(19) United States
(12) Patent Application Publication
(10) Pub. No.: US 2003/0225877 A1
(43) Pub. Date: Dec. 4, 2003

(54) Method and apparatus of diagnosing network performance issues through correlative analysis

(76) Inventors: Eric Packman, Montreal (CA); Ying Hu, Montreal (CA)

Correspondence Address: Steven J. Henry, Wolf, Greenfield & Sacks, P.C., 600 Atlantic Avenue, Boston, MA, 02210, US

(21) Appl. No.: 10/160,608

(22) Filed: May 31, 2002

(51) Int. Cl. G06F 15/173

(52) U.S. Cl. 709/224

(57) ABSTRACT

A method, apparatus, and computer-readable medium are provided for determining at least one relationship between a plurality of measures observed on at least one node in a network over a plurality of time samples. Each measure comprises a performance indication exhibited by the at least one node. The plurality of measures are collected from the at least one node, and compared to identify at least one relationship (in some cases, a correlation) between measures.

### FIELD OF THE INVENTION

This invention relates to network monitoring software, and more particularly to software and methods for diagnosing network and node performance issues.

### BACKGROUND OF THE INVENTION

Computer networks (i.e., computer systems linked to one another via a communications network) continue to grow in ubiquity due to the information access and increased productivity they offer, and the technological advances that have improved their reliability. Typically, computer networks consist of at least one server system, which is usually a computer tasked with responding to requests (usually in the form of transactions) from other computers on the network, and at least one client computer system, which is typically an individual workstation employed by a user to request that information. The Internet is the largest and most widely used computer network, although local- and wide-area networks, and other public and private networks, are also widely deployed.

As the acceptance and size of computer networks (hereinafter “networks”) increases, and as we rely more upon them, the importance of assuring network and server performance, and need for effective network management tools, increases as well. Typically, network management tools include software applications (for execution by processors on the network) containing instructions for collecting network node (e.g., server) and application performance data, identifying and analyzing the data, and displaying the data to one or more users (usually network management personnel, also known as network managers). By using network management tools to collect and analyze performance data from network devices and applications executing on them, network managers attempt to recognize or anticipate problems. For example, a network manager may look to identify the cause of a network slowdown by studying the average latency for a given server, or the response time for a given application. Most conventional network management tools are capable of providing this and other data. Generally, network managers can analyze the data to recognize current or impending bottlenecks, such as a growing load on a server or an inordinate amount of time required to access an application, and this information can sometimes be useful for planning corrective action.

At times, however, the usefulness of the data produced by conventional tools is limited by its sheer volume. While producing abundant information indicative of performance levels, including problems, many tools fail to help identify the exact cause of problems, particularly when those problems are subtle or intermittent. For example, for a network request not processed within an acceptable time, tools may provide data describing the transaction's passage through potentially dozens of networking components, a load balancer, one or more servers, and an application. In instances where the Internet comprises at last a portion of the network in question, the data can grow exponentially, since each user “session” with a web site can result in dozens of individual transactions, each of which may be processed by a host of devices and applications. A user's point of Internet access may comprise a series of servers and devices, the Internet itself might pass each transaction across a series of routers, bridges and other devices, and the destination web site's hosting facility may utilize a number of routers, firewalls, load balancers, web servers, application servers, data base servers and other devices. Furthermore, with each new component added to a network infrastructure, relationships between devices, applications, and combinations thereof become more difficult to identify. This is exacerbated by the fact that each additional component becomes responsible for less and less of the entire system's performance. Very quickly, the complexity of an infrastructure, and the bulk of information collected from it, can become far too unwieldy for a network manager to analyze and respond to on a timely basis.

As a result, network managers are often forced to dig through incredible amounts of data to find correlations between a problem and the performance of underlying components, and usually in an iterative manner. Even identifying simple, one-to-one cause-and-effect relationships can be an extremely difficult exercise. When the complexity is compounded by the fact that the cause of a problem is not one component but several, the task can be next to impossible. To see why, one need only examine the quantity of combinations possible within a very simple network architecture: suppose server A has two properties, Aᵢ and Aᵢᵢ, each denoting the performance of a component; server B has two properties: Bᵢ and Bᵢᵢ; and server C has three properties, Cᵢ, Cᵢᵢ and Cᵢᵢᵢ. Bᵢ could be correlated to (i.e., it could influence or be influenced by) Aᵢᵢ, or Bᵢ might be correlated to Aᵢ plus Aᵢᵢ plus Cᵢᵢᵢ more strongly than simply Aᵢᵢ on its own. With this set of only seven properties, 966 possible combinations exist, each of which may represent the cause of a problem. A network manager might rely on experience and expertise to sift through the data selectively, but if a diagnosis is not immediately apparent, the number of components within a typical infrastructure, and the number of performance indications potentially exhibited by each, can easily make this a very daunting task.

Aside from the sheer volume of data to analyze, relationships are often subtle, counterintuitive or otherwise difficult to identify, and data may not be readily available in a form conducive to simple comparisons. For instance, processor usage, which is typically expressed as a percentage of its capacity, may not lend itself easily to a comparison with server latency, which is commonly expressed as a duration to achieve a response. Also, some correlations may be time delay-dependent, requiring a (potentially variable) period to elapse before a relationship becomes evident. Finally, the cause-and-effect relationship between the performance of two components may not be readily identifiable as such until the indications have been observed together over an extended period.

Given the increasingly networked nature of business, and given the growth of the Internet as a commerce tool, the ability to ensure that computer networks can continue to efficiently process transactions is of great value. Therefore, tools and/or methods not requiring extensive, time-consuming analysis to facilitate the diagnosis of bottlenecks are needed and, in a short time, have proven to be of great value.

### SUMMARY OF THE INVENTION

According to one aspect of the invention, a method is provided for determining at least one relationship between a plurality of measures observed on at least one node in a network over a plurality of time samples, wherein each measure comprises a performance indication exhibited by the at least one node, comprising collecting the plurality of measures from the at least one node, and comparing at least one measure with at least one other measure to identify at least one relationship between measures.

The plurality of measures may be observed on a plurality of nodes or on a single node. The relationship between measures may include at least one correlation. The method may further comprise normalizing at least two of the plurality of measures, and comparing at least one normalized measure with at least one other normalized measure. The method may even further include producing at least two combinations of normalized measures, and comparing at least one combination of normalized measures with at least one other combination of normalized measures. The method may further include displaying at least one correlation to a user, via an output device, as a function of time. Intervals between time samples may be uniform in length, and may be sequential.

According to a second aspect of the invention, an apparatus is provided for determining at least one relationship between a plurality of performance measures observed on at least one node in a network over a plurality of time samples, wherein each measure comprises a performance indication exhibited by the at least one node, comprising a monitor to collect the plurality of measures from the at least one node, and a first processing engine executing instructions to compare at least one measure with at least one other measure to determine at least one relationship.

The apparatus may further comprise a second processing engine executing instructions to normalize at least two measures, and compare at least one normalized measure with at least one other normalized measure, a storage element to store data defining the performance of the at least one node wherein the data includes representations of at least one of a measure, a normalized measure, and a relationship, and/or an output device to display at least one relationship to a user as a function of time.

According to a third aspect of the invention, a computer-readable medium is provided having instructions recorded thereon, which instructions, when executed, cause at least one processor in a computer system to collect a plurality of measures from at least one node in a network, wherein the measures comprise performance indications exhibited by the at least one node, and determine at least one relationship between at least one measure and at least one other measure.

The computer-readable medium may further comprise instructions defining identifying at least one correlation between measures, instructions defining normalizing at least two of the plurality of measures and comparing at least one normalized measure with at least one other normalized measure, instructions defining producing at least two combinations of normalized measures and comparing at least one combination of normalized measures with at least one other combination of normalized measures, instructions defining sorting the at least one correlation to produce an ordered list, and/or instructions defining displaying at least one relationship to a user via an output device as a function of time.

According to a fourth aspect of the invention, a method is provided for determining at least one relationship between a plurality of measures observed on at least one node in a network over a plurality of time samples, wherein each measure comprises a performance indication exhibited by the at least one node, comprising comparing at least one measure observed on a node with at least one other measure observed on a node, to identify at least one relationship between measures. The plurality of measures may be observed on a plurality of nodes or on a single node. The method may further comprise identifying at least one correlation between measures.

The foregoing and other aspects and advantages provided by the invention will be more fully understood from the following detailed description of illustrative embodiments which follows, said description to be read in connection with the annexed drawings.

### BRIEF DESCRIPTION OF THE DRAWINGS

In the drawings, in which like reference designations indicate like elements:

FIG. 1 is a functional block diagram of a hardware system on which aspects of the invention might execute;

FIG. 2 is a functional block diagram of the storage component of the system of FIG. 1;

FIG. 3 is a block diagram of an exemplary system architecture on which aspects of the invention might be employed;

FIG. 4 is a flow chart depicting the acts performed to gather data and determine correlations between the performance of system components; and

FIG. 5 is a flow chart depicting the acts performed to calculate correlations.

### DETAILED DESCRIPTION

Through appropriate embodiments, aspects of the invention may be instantiated to overcome the limitations of conventional network management tools. Methods, apparatus and computer-readable media are provided for more efficient and accurate analysis of performance data exhibited by a complex network infrastructure, through the identification of strong correlations between performance indications and combinations of indications, to facilitate improved network problem diagnosis and capacity planning. In order to better understand how such instantiation may be accomplished, we first describe the computer system components with which the embodiments may be implemented.

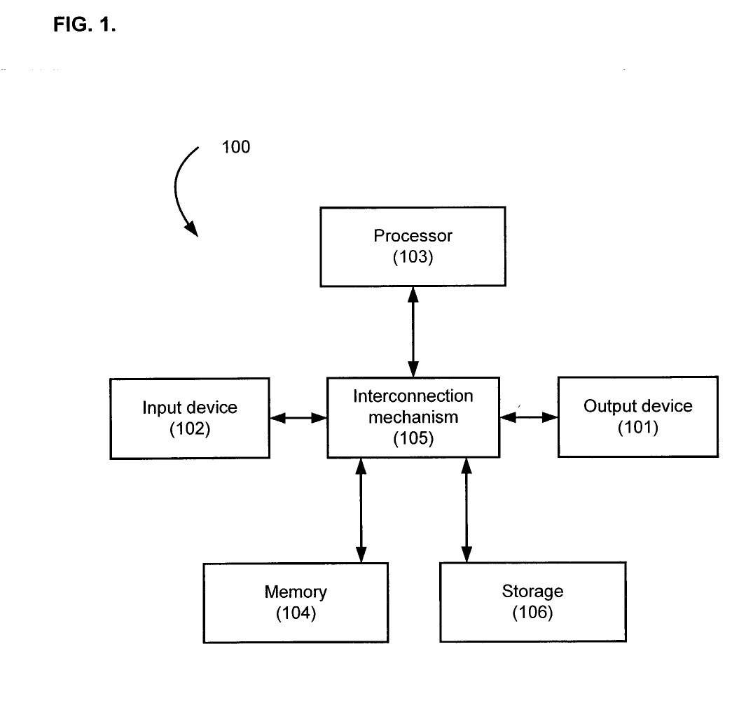

Implementation of these methods, apparatus, and computer-readable medium is typically accomplished using a computer system 100 like that depicted in FIG. 1. Computer system 100 includes at least one main unit configured to communicate over a communications network, such as, for example, a local-area network, a wide-area network, a wireless network (radio frequency, microwave, satellite, electromagnetic radiation, or the like) or a communications network that consists of any combination of the foregoing. Computer system 100 may be connected to the communications network (not shown) through means such as, for example, cable, fiber, digital subscriber line (DSL), plain old telephone service (POTS), or the like. The main unit may be connected to one or more output devices 101 that store information, display information or transmit information to one or more users or machines (e.g., over a network), and one or more input devices 102 which receives input from one or more users or machines (e.g., over a network). The main unit may include one or more processors 103 connected to a memory system 104 via one or more interconnection mechanisms 105, such as a bus or switch. Any input device 102 and/or output device 101 are also connected to the processor 103 and memory system 104 via the interconnection mechanism 105. The computer system 100 may further include a storage system 106 in which information is held on or in a non-volatile medium. The medium may be fixed in the system or may be removable.

Computer system 100 may instead be a distributed system, and therefore may not include a main unit. In particular, elements such as input devices 102, processors 103, memory systems 104, interconnection mechanisms 105, and storage systems 106 may each comprise individual or multiple elements or computer systems, at least some of which may be geographically dispersed. For example, storage systems 106 may comprise a series of servers residing in New York communicating via the Internet with a processor 103 in Pennsylvania. In this instance the Internet may serve as interconnection mechanism 105. Computer system 100 may also be a multi-processor computer system, a massively-parallel computer system, or may include multiple computers connected over a communications network and configured to perform parallel and/or distributed processing.

Computer system 100 may be a general purpose computer system which is programmable using a computer programming language such as C, C++, Java, and/or Visual Basic or others. Computer programming languages suitable for implementing such a system include procedural programming languages, object-oriented programming languages, combinations of the two, or other languages. The computer system may also be specially programmed, special purpose hardware, or an application specific integrated circuit (ASIC).

In a general purpose computer system, the processor is typically a commercially available microprocessor, such as a Pentium series processor available from Intel or other commercially available processor, which executes a program called an operating system, such as UNIX, Linux, MacOS, BeOS, Solaris, Windows NT, Windows 95, 98, or 2000 or other commercially available operating system, which controls the execution of other computer programs and provides scheduling, debugging, input/output control, accounting, compilation, storage assignment, data management, memory management, communication control and related services. The processor and operating system defines the platform for which application programs in other computer programming languages are written. The invention is not limited to any particular processor, operating system or programming language.

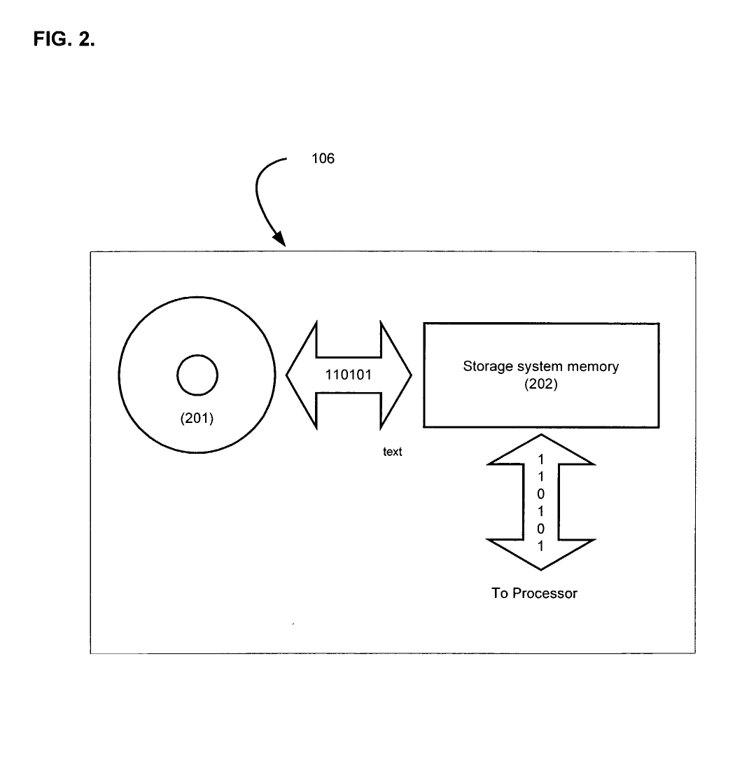

Storage system 106, shown in greater detail in FIG. 2, typically includes a non-volatile recording medium 201, in which data is stored that define a program to be executed by the processor, or information stored to be processed by the program. The medium may, for example, be a disk or flash memory. Typically, in operation, the processor causes data to be read from the non-volatile recording medium 201 into another memory 202 that allows for faster access to the information by the processor than does the medium 201. This memory 202 is typically a volatile, random access memory such as a dynamic random access memory (DRAM) or static memory (SRAM). It may be located in storage system 106, as shown, or in memory system 104, not shown. The processor 103 generally manipulates the data within the integrated circuit memory 104, 202 and then copies the data to the medium 201 after processing is completed. A variety of mechanisms are known for managing data movement between the medium 201 and the integrated circuit memory element 104, 202, and the invention is not limited thereto. The invention is not limited to a particular memory system 104 or storage system 106.

Aspects of embodiments of the invention may be implemented in software, hardware or firmware, or combination thereof. Various aspects of an embodiment, either individually or in combination, may be implemented as a computer program recorded on a computer-readable medium such as storage system 106 for access and execution by a processor such as processor 103. When executed by processor 103, instructions instruct processor 103 to perform various steps and acts of the process.

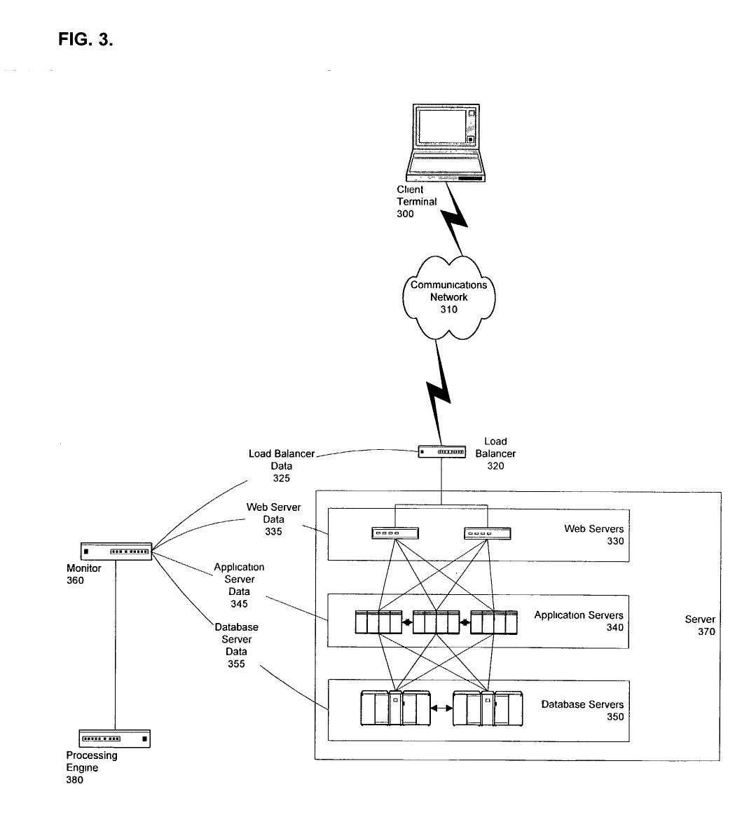

FIG. 3 depicts one example of a conventional network architecture implemented to support a site on the World Wide Web, which is adapted to deploy aspects of embodiments of the invention. FIG. 3 depicts exemplary network nodes client terminal 300 and server 370 which may be embodiments of computer system 100. Client terminal 300 requests information from server 370 by issuing a request through communications network 310. Communications network 310 may be the Internet, a direct dial-up network, a wireless network, other public or private communications network, or combination thereof. The request is received by load balancer 320, which may distribute incoming requests across multiple web servers 330 so that the load on any one server does not become too great, and may also serve to insulate web servers 330 from direct exposure to communications network 310. Of course, the invention is not limited to being implemented on the architecture depicted in FIG. 3; for example, web servers 330 could be directly connected to the network or node(s), and multiple load balancers 320 might be employed.

Web servers 330 may store and serve static content themselves, or may work in conjunction with application servers 340 and database servers 350 to fulfill more complicated requests, such as dynamically generated or other data-driven content. Application servers 340 may serve as intermediaries between web servers 330 and database servers 350, and may perform processing for serving dynamically generated content. As is generally understood in the art, application servers 340 may provide support to applications running on database servers 350 including transaction management, security, threading, server process hosting, event handling, synchronous and asynchronous messaging and other services. The application server may be developed using CORBA, COM/DCOM, Enterprise Java Beans (EJB), or other application development architecture.

Database servers 350 typically execute database applications which store and retrieve data requested by users. These applications may be any kind of database, including a relational database, unstructured database, hierarchical database, time-series database, or other database. Database servers 350 may work in conjunction with application servers 340 and web servers 330 to transmit requested data back to users. Database servers 350 may also authenticate users and/or maintain user session state. Collectively, web servers 330, application servers 340 and database servers 350 comprise server 370, which may utilize various combinations of components therein to fulfill user requests. Load balancer 320 and various components of server 370 may comprise one or more embodiments of computer system 100. The configuration of server 370, as depicted in FIG. 3, should not be considered limiting. Any number of web servers 330, application servers 340 and/or database servers 350 may be employed, and communication links other than those depicted in FIG. 3 may be utilized.

In the embodiment depicted in FIG. 3, monitor 360 collects performance data from devices and applications, and may comprise software executing on a general purpose computer connected via any communications medium to load balancer 320, web servers 330, application severs 340 and/or database servers 350. From these respective components, monitor 360 may receive load balancer data 325, web server data 335, application server data 345, database server data 355, a subset thereof, or this and other data. Monitor 360 may also collect or receive data from other networking devices in the infrastructure, such as routers, switches, and other components. Each data set received comprises indications of the component's performance (hereinafter performance indications or measures). A component may comprise a device, an application running on the device, or other system element. Monitor 360 may be connected via any networking medium to load balancer 320, web servers 330, application servers 340 and/or database servers 350 and may accomplish physical data transfer using access methods including Ethernet, token-ring, and others. Load balancer 320, web servers 330, application servers 340 and database servers 350 may be similarly interconnected using the same or different access methods.

In the embodiment depicted, processing engine 380 receives performance data 325, 335, 345 and 355 from monitor 360 and analyzes the data to compute correlations between performance indications of various components. The mechanics of these computations are described in further detail in subsequent paragraphs.

Processing engine 380 is depicted in FIG. 3 as residing in a separate computer system than monitor 360, but is not limited to the depicted configuration; processing engine 380 may be a software application executing on a general purpose computer connected to a separate computer on which monitor 360 executes, processing engine 380 and monitor 360 may execute on the same computer, or they may be otherwise integrated. Further, monitor 360 and processing engine 380 may be separate modules of the same computer program, or separate program objects utilized by the same object-oriented architecture. In other embodiments, either processing engine 380 or monitor 360, or both, may comprise hardware or firmware components.

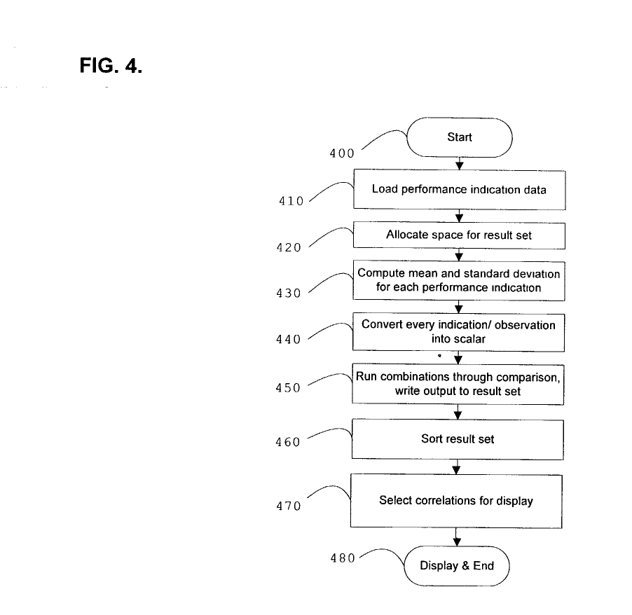

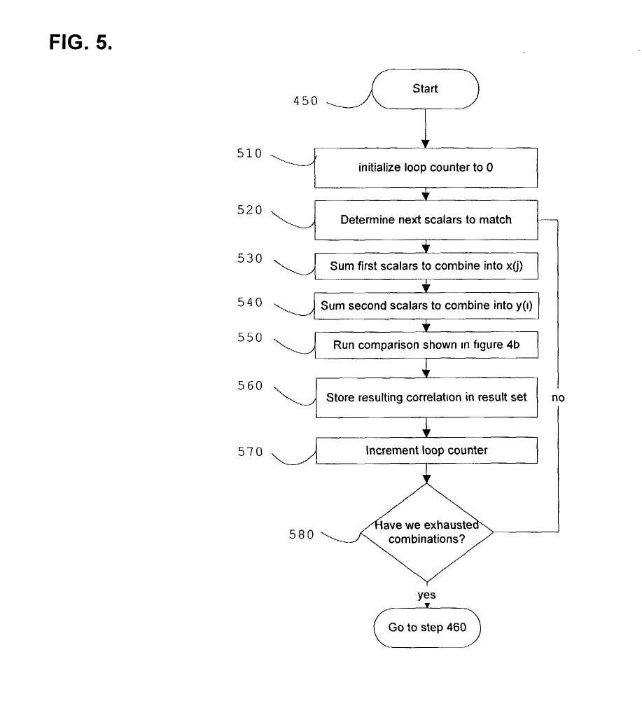

As discussed in the foregoing, correlations are determined to identify strong relationships between the performance of individual components, i.e., relationships that may dictate efficient network and node operation. FIGS. 4 and 5 collectively depict a processing flow defining one embodiment of a method for determining these correlations. This and other method embodiments may be defined by instructions residing on computer-readable media such as that which might reside in storage system 106, including, but not limited to, magnetic disk, optical disk, magneto-optical disk, tape, and other media. Each step, act or sub-act shown in FIGS. 4 and 5 may comprise instructions within separate modules of a single computer program or separate programs. Programs may execute on one or more computer systems. Instructions defining each step, act, or sub-act may be performed by monitor 360, processing engine 380, or a combination of the two. Output may be placed in a storage system such as storage system 106.

The processing flow starts with act 400, which may begin at any time (including previously scheduled, random, user-invoked, or other times). Act 400 may begin a process that is repeated at regular intervals, repeated at random intervals, or executed only once.

In act 410, a plurality of performance measures is collected from one or more system components, such as devices, software applications, or other system elements. Collection may entail retrieval by, or transmission to, monitor 360, which may store collected data as an array of vectors or in another form. Data retrieval may entail the use of monitors, probes, “sniffers”, or other methods or tools. Performance measures may be observed at a single time sample or multiple time samples. Time samples need not be sequential or separated by intervals of equal length. Some performance measures may be observed at a single time sample, but others may require observation over multiple time samples (e.g., latency must be collected over multiple time samples, given that it is defined by the interval between request and response). In certain embodiments, a subset of performance measures may be collected at a first time sample, and another at a second time sample.

In act 420, a quantity of correlations that the process will determine is defined, so that system constraints can be appropriately managed. Given the quantity of correlations which could be drawn between a large number of performance measures (and between combinations of measures), this act allows for potential system impacts to be mitigated. Some embodiments may include a software routine which estimates for a user the system impact of performing these calculations, such as total processing time, processor usage, storage required for resulting data and input, and/or other indications. These embodiments may initialize a result set given the results of this process. If the system does not provide for the quantity of correlations to be limited, in act 420 a result set may be initialized based on the maximum number of correlations that can be drawn from a given number of performance measures and combinations thereof, given by:

$${\sum }_{k = 1}^{n - 1} {\sum }_{j = 1}^{n - k} {C}_{n}^{k} {C}_{n - k}^{j}$$

where n is the number of performance measures, k is a first element, j is a second element, Cₙ equals (n!/k!(n−k)!), and Cₙ₋ₖ equals ((n−k)!/k!(n−k)!).

In act 430, means and standard deviations are calculated to provide input for, and thus to expedite, subsequent processing steps. In some embodiments, based on the outcome of act 420, means and standard deviations may be calculated for a subset of performance indications, or for the entire population. In other embodiments, act 430 may not be performed at all.

In the embodiment depicted, in act 440, performance indications are normalized (i.e., scalars are produced). Normalization serves at least two very valuable purposes. First, it makes easier the process of drawing correlations between performance indications by providing a universal and uniform scale. Second, it makes easier the process of combining measures which are expressed in heterogeneous numerical terms. For at least these reasons, normalization enables the efficient, automated determination of correlations between performance indications. In this embodiment, a scalar is produced by comparing the measure at an observation (i.e., at a specific time sample) with all observations (at all time samples). In one such embodiment, a scalar for a measure at a time sample is given by:

$${Z}_{i} ( x ) = \frac{{x}_{i} - \overline{x}}{σ}$$

where xᵢ is the measure at time sample i, \overline{x} is the mean of the measure over all observations, and σ is the standard deviation of the values of x. In other embodiments, normalization may be performed in different ways. In still other embodiments, normalization may not be performed at all.

In act 450, correlations are drawn between measures. One embodiment of a method for calculating correlations is depicted in greater detail in FIG. 5. In act 510, a loop counter is initialized to zero. In act 520, input to the correlation calculation (i.e., the specific performance measures or combination of measures which are to be correlated) is defined. If at least one element to be correlated is a combination of measures, they are combined in steps 530 and 540. In some embodiments, combination may be accomplished by calculating the sum of normalized measures. In other embodiments, combinations of measures may be produced using other techniques.

In step 550, a correlation is calculated. As discussed in the foregoing, a correlation may be drawn between individual performance measures, between an individual measure and a combination of measures, or between two combinations of measures. (Because measures and combinations of measures comprise variations on the same input to this calculation, the term “measure,” when used herein, may refer to either.) In one embodiment, a correlation between measures is given by:

$$r = {( \frac{{\sum }_{i = 1}^{n} ( {x}_{i} - \overline{x} ) ( {y}_{i} - \overline{y} )}{\sqrt{( {\sum }_{i = 1}^{n} {( {x}_{i} - \overline{x} )}^{2} ) ( {\sum }_{i = 1}^{n} {( {y}_{i} - \overline{y} )}^{2} )}} )}^{2}$$

where x is a first measure, y is a second measure, n is a number of time samples over which x and y have been observed, xᵢ is the first measure at time sample i, yᵢ is the second measure at time sample i, \overline{x} is a mean of the first measure over all observed time samples, and \overline{y} is a mean of the second measure over all observed time samples. In other embodiments, the correlations may be determined using other calculation techniques.

In the embodiment depicted, in act 560, the calculation result is stored in the result set initialized in act 420. The result set may be stored in storage system 106. In some embodiments, the system may allow the user to define data associated with the calculation (for example, input or other associated elements) in the result set as well.

In act 570, the loop counter initialized in step 510 is incremented. Act 580 comprises a decision point. If the loop counter value equals the number of correlations to be calculated, as determined in act 420, the process proceeds to step 460. If not, the process returns to act 520 and continues through the loop depicted in FIG. 5.

After the completion of the loop (i.e., when the loop counter equals the number of correlations to be calculated), in act 460 (FIG. 4) the result set is sorted to produce an ordered list. In some embodiments, the resulting list may be sorted from a maximum to a minimum correlation. In other embodiments, other sort orders may be used. Any sort function may be employed to produce the ordered list, including a bubble sort, a quicksort, and/or others.

In the embodiment shown, in act 470 a subset of relevant correlations is selected for display to the user. In one embodiment, this selection may be based on a predetermined threshold (for example, correlations with a value greater than 70%). In other embodiments, correlations may be selected for display that are most different from a previous result set. Still other embodiments may use other techniques. In act 480, output is displayed to the user using output device 101. Output may take many forms, including hard copy, screen display, a list of icons, or others.

The processes described in reference to FIGS. 4 and 5 can be extremely useful for identifying the cause of performance issues attributable to anomalous system behavior. For instance, one example of a performance issue diagnosed using the invention involved a web site plagued by high latency (i.e., slow response time) for certain uniform resource locators (URLs). Standard tests (i.e., not involving the processes described herein) revealed no associated increase in CPU or memory usage when users attempted to access the URLs, and a counterintuitive relationship seemed to exist between system usage and latency: the higher the number of users accessing the site, the lower the latency of the affected URLs. Without employing the invention, identifying the cause of this problem might have been extremely time-consuming, but by using these tools and techniques Applicants were able to quickly identify a strong correlation between system errors per second and the latency of the affected URLs. This caused Applicants to question why there were so many system errors, and to theorize that the system, instead of responding to requests in the correct manner, was simply responding with error messages (a much less resource-intensive task). This theory proved to be correct, and appropriate corrective measures were then evident. Without using the invention to identify this relationship, this could have been a difficult, time-consuming, and expensive problem to diagnose.

Applicants also appreciate, however, that only a subset of the correlations identified by the invention will be meaningful relationships, i.e., relationships that are indicative of system efficacy. For instance, the invention may indicate that memory usage of one server happens to be highly statistically correlated over a certain period with the CPU usage of another server, but this correlation may not be meaningful in predicting the performance of the system in relation to either. In some embodiments, then, performance data may be analyzed for patterns which provide further diagnostic intelligence. Patterns may include correlations which prove to be consistently strong over an extended period, which are consistently examined by users, which emerge at certain intervals or network conditions, which conform to predefined business rules, or which exhibit other behavior. In these and other embodiments, these patterns may dictate which correlations are selected for display to a user. This selection may be performed by programmed instructions like those discussed in reference to FIGS. 4 and 5.

While the invention has been particularly shown and described with reference to specific embodiments, these embodiments are presented by way of example only, as it is not possible to enumerate all potential implementations. It should be understood by those skilled in the art that various changes in form and detail may be made therein without departing from the spirit and scope of the invention, which is defined in the following claims.

1. A method of determining at least one relationship between a plurality of measures observed on at least one node in a network over a plurality of time samples, wherein each measure comprises a performance indication exhibited by the at least one node, comprising the acts of:
(a) collecting the plurality of measures from the at least one node;
(b) comparing at least one measure with at least one other measure to identify at least one relationship between measures.

2. The method according to claim 1, wherein the plurality of measures are observed on a plurality of nodes.

3. The method according to claim 1, wherein the plurality of measures are observed on a single node.

4. The method according to claim 1, wherein the act (b) further comprises identifying at least one correlation between measures.

5. The method according to claim 4, further comprising an act of:
(c) sorting the at least one correlation to produce an ordered list of correlations.

6. The method according to claim 5 wherein the ordered list is sorted from a maximum to a minimum correlation.

7. The method according to claim 1, wherein act (a) further includes an act of normalizing at least two of the plurality of measures, and act (b) further includes an act of comparing at least one normalized measure with at least one other normalized measure.

8. The method according to claim 7, wherein the plurality of measures comprises at least two combinations of normalized measures, and comparing includes comparing at least one combination of normalized measures with at least one other combination of normalized measures.

9. The method according to claim 7 wherein normalizing a measure x includes calculating:
$${Z}_{i} ( x ) = \frac{{x}_{i} - \overline{x}}{σ}$$
where Zᵢ(x) is a normalized measure at time sample i, xᵢ is the measure at time sample i, \overline{x} is the mean of the measure over the population of observed time samples, and σ is the standard deviation of values of x.

10. The method according to claim 4 wherein act (b) is performed by calculating:
$$r = {( \frac{{\sum }_{i = 1}^{n} ( {x}_{i} - \overline{x} ) ( {y}_{i} - \overline{y} )}{\sqrt{( {\sum }_{i = 1}^{n} {( {x}_{i} - \overline{x} )}^{2} ) ( {\sum }_{i = 1}^{n} {( {y}_{i} - \overline{y} )}^{2} )}} )}^{2}$$
where x is a first measure, y is a second measure, n is a number of time samples over which x and y have been observed, xᵢ is the first measure at time sample i, yᵢ is the second measure at time sample i, \overline{x} is a mean of the first measure over the observed population of time samples, \overline{y} is a mean of the second measure over the observed population of time samples, and r is the correlation between measures x and y.

11. The method according to claim 4 further including an act of:
(d) displaying at least one correlation to a user, via an output device, as a function of time.

12. The method according to claim 1, wherein intervals between time samples are uniform in length.

13. The method according to claim 1, wherein time samples are sequential.

14. An apparatus for determining at least one relationship between a plurality of performance measures observed on at least one node in a network over a plurality of time samples, wherein each measure comprises a performance indication exhibited by the at least one node, comprising:
a monitor to collect the plurality of measures from the at least one node;
a first processing engine executing instructions to compare at least one measure with at least one other measure to determine at least one relationship.

15. The apparatus according to claim 14, further comprising a second processing engine executing instructions to normalize at least two measures, and compare at least one normalized measure with at least one other normalized measure.

16. The apparatus according to claim 14, further comprising a storage element to store data defining the performance of the at least one node, wherein the data includes representations of at least one of a measure, a normalized measure, and a relationship.

17. The apparatus according to claim 14, further comprising an output device to display at least one relationship to a user as a function of time.

18. A computer-readable medium having instructions recorded thereon, which instructions, when executed, cause at least one processor in a computer system to:
(a) collect a plurality of measures from at least one node in a network, wherein the measures comprise performance indications exhibited by the at least one node;
(b) determine at least one relationship between at least one measure and at least one other measure.

19. The computer-readable medium according to claim 18, further comprising instructions defining identifying at least one correlation between measures.

20. The computer-readable medium according to claim 18, further comprising instructions defining normalizing at least two of the plurality of measures, and comparing at least one normalized measure with at least one other normalized measure.

21. The computer-readable medium according to claim 18, further comprising instructions defining producing at least two combinations of normalized measures, and comparing at least one combination of normalized measures with at least one other combination of normalized measures:

22. The computer-readable medium according to claim 19, further comprising instructions defining sorting the at least one correlation to produce an ordered list of correlations.

23. The computer-readable medium according to claim 22, further comprising instructions defining sorting the ordered list from a maximum to a minimum correlation.

24. The computer-readable medium according to claim 20, further comprising instructions defining normalizing at least one of the plurality of measures by:
$${Z}_{i} ( x ) = \frac{{x}_{i} - \overline{x}}{σ}$$
where Zᵢ(x) is a normalized measure at time sample i, xᵢ is the measure at interval i, \overline{x} is the mean of the measure over the population of observed time samples, and σ is the standard deviation of values of x.

25. The computer-readable medium according to claim 18, further comprising instructions defining determining a correlation by:
$$r = {( \frac{{\sum }_{i = 1}^{n} ( {x}_{i} - \overline{x} ) ( {y}_{i} - \overline{y} )}{\sqrt{( {\sum }_{i = 1}^{n} {( {x}_{i} - \overline{x} )}^{2} ) ( {\sum }_{i = 1}^{n} {( {y}_{i} - \overline{y} )}^{2} )}} )}^{2}$$
where x is a first measure, y is a second measure, n is a number of time samples over which x and y have been observed, xᵢ is the first measure at time sample i, yᵢ is the second measure at time sample i, \overline{x} is a mean of the first measure over the observed intervals, \overline{y} is a mean of the second measure over the observed intervals, and r is the correlation between measures x and y.

26. The computer-readable medium according to claim 18, further comprising instructions defining displaying at least one relationship to a user via an output device as a function of time.

27. A method of determining at least one relationship between a plurality of measures observed on at least one node in a network over a plurality of time samples, wherein each measure comprises a performance indication exhibited by the at least one node, comprising the act of:
(a) comparing at least one measure observed on a node with at least one other measure observed on a node to identify at least one relationship between measures.

28. The method according to claim 27, wherein the plurality of measures are observed on a plurality of nodes.

29. The method according to claim 27, wherein the plurality of measures are observed on a single node.

30. The method according to claim 27, wherein the act (a) further comprises identifying at least one correlation between measures.
